(19) United States
(12) Patent Application Publication
(10) Pub. No.: US 2021/0223061 A1
(43) Pub. Date: Jul. 22, 2021

(54) OBJECT IDENTIFICATION DEVICE, ROADSIDE APPARATUS, AND OBJECT IDENTIFICATION METHOD

(71) Applicant: MITSUBISHI ELECTRIC CORPORATION, Tokyo (JP)

(72) Inventors: Kyoko Hosoi, Tokyo (JP); Kenichi Nakura, Tokyo (JP); Takeshi Suehiro, Tokyo (JP)

(73) Assignee: MITSUBISHI ELECTRIC CORPORATION, Tokyo (JP)

(21) Appl. No.: 16/496,352

(22) PCT Filed: May 17, 2017
(86) PCT No.: PCT/JP2017/018570

§ 371 Date: Sep. 20, 2019

(51) Int. Cl. G01C 21/00; G08G 1/01; G08G 1/052; G08G 1/056

(52) U.S. Cl. CPC G01C 21/3811; G01C 21/3815; G01C 21/3848; G08G 1/056; G08G 1/0116; G08G 1/0141; G08G 1/052; G01C 21/3893

(57) ABSTRACT

An object identification device includes: a region determination unit that acquires observed position information indicating positions at which an object is observed, and determines whether each position is in any one of regions into which an area indicated is divided; a road reference position conversion unit that converts each position in the region, into a traveling direction position parallel to an assumed road direction and a transverse direction position perpendicular to the assumed road direction; and a comparison unit that rearranges the positions in order of the traveling direction, creates pairs of front and rear positions, calculates a difference in the traveling direction positions and the transverse direction positions between each pair of positions, and determines that a pair of positions between which the differences are within thresholds specified in respective items are derived from the same object, and a pair of positions between which at least one of the differences is greater than the threshold are derived from different objects.

### FIELD

The present invention relates to an object identification device, a roadside apparatus, and an object identification method for identifying objects at the roadside.

### BACKGROUND

The realization of automatic traveling is desired which uses a system equipped with artificial intelligence as a driver, in place of a human. In order to realize the automatic traveling, a map with a fast update cycle including various information such as movements of surrounding vehicles and people is required, instead of a map with a low update frequency in which roads, buildings, etc. are shown. Such a map with a fast update cycle, that is, a map including dynamic information is called a dynamic map. In the creation of a dynamic map, an update cycle of 100 ms or less is required. It is necessary in the creation of a dynamic map to collect information on observed positions of objects observed by a plurality of sensors such as radars installed at the roadside, identify the same object, and deliver information on the observed position. Patent Literature 1 discloses a technique to identify the same object in an aircraft using a tracking function by radar.

### CITATION LIST

### Patent Literature

Patent Literature 1: Japanese Patent Application Laid-open No. 2006-153736

### SUMMARY

### Technical Problem

However, according to the above conventional technique, the identification of observed positions acquired at different times is determined based on whether a subsequent observed position is observed in an estimated error ellipsoid, assuming that an object has made a uniform linear motion from a previous observed position. Further, in order to continue identification when an object turns, it is necessary to calculate observed positions, considering all motion models such as left turning motion and right turning motion in addition to a uniform linear motion model. Consequently, there is a problem of high processing load in the identification of the same object.

The present invention has been made in view of the above. It is an object of the present invention to provide an object identification device capable of reducing the load of processing to identify objects.

### Solution to Problem

In order to solve the problem described above and achieve the object, an object identification device of the present invention includes a map information storage unit that stores map information that is information on a road. The object identification device further includes a region determination unit that acquires observed position information indicating observed positions at which an object is observed from a plurality of sensors, and determines whether each observed position is in any one of regions into which an area indicated by the map information is divided, and a road reference position conversion unit that converts each observed position determined to be in the region of the map information, into a traveling direction position indicating a position in a direction parallel to an assumed road direction in the region indicated by the map information, and a transverse direction position indicating a position in a direction perpendicular to the assumed road direction in the region, using the map information. The object identification device further includes a comparison unit that rearranges the observed positions after the position conversion in order of the traveling direction, creates pairs of front and rear observed positions in the traveling direction, calculates a difference in the traveling direction positions and a difference in the transverse direction positions between each pair of observed positions, and determines that a pair of observed positions between which the differences are within thresholds specified in respective items are derived from the same object, and determines that a pair of observed positions between which at least one of the differences is greater than the threshold are derived from different objects.

### Advantageous Effects of Invention

The object identification device according to the present invention has an advantage of being able to reduce the load of processing to identify objects.

### BRIEF DESCRIPTION OF DRAWINGS

FIG. 1 is a block diagram illustrating a configuration example of an object identification device included in a roadside apparatus.

FIG. 2 is a graph illustrating an example in which observed positions of objects observed by a device having no map information are plotted in a relative coordinate system parallel to latitude and longitude.

FIG. 3 is a graph illustrating an example in which observed positions of objects observed by the object identification device are plotted together with an assumed road position.

FIG. 4 is a diagram illustrating relative distances of the objects to the road substituted for the observed positions by the object identification device.

FIG. 5 is a diagram illustrating an example of the contents of map information stored in a map information storage unit of the object identification device.

FIG. 6 is a flowchart illustrating the operation of the object identification device.

FIG. 7 is a diagram illustrating an example of processing to convert observed position information into a traveling direction position in a region and a transverse direction position in the region in the object identification device.

FIG. 8 is a diagram illustrating an example when a device storing no map information erroneously determines that two observed positions are derived from the same object.

FIG. 9 is a diagram illustrating an example of a case where a processing circuit of the object identification device is formed of a processor and memory.

FIG. 10 is a diagram illustrating an example of a case where a treatment circuit of the object identification device is formed of dedicated hardware.

### DESCRIPTION OF EMBODIMENTS

Hereinafter, an object identification device, a roadside apparatus, and an object identification method according to an embodiment of the present invention will be described in detail with reference to the drawings. Note that the embodiment is not intended to limit the invention.

### Embodiment

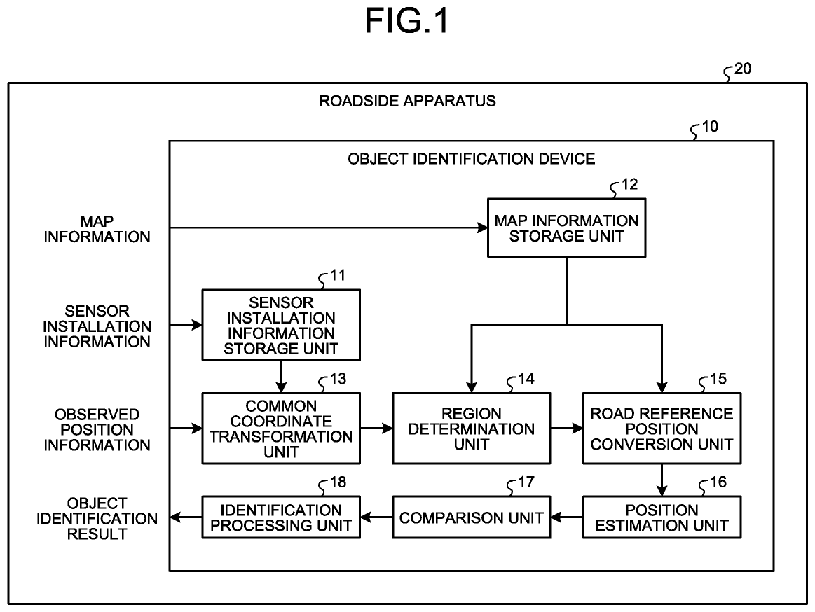

FIG. 1 is a block diagram illustrating a configuration example of an object identification device 10 included in a roadside apparatus 20 according to an embodiment of the present invention. The roadside apparatus 20 is an apparatus such as an edge node installed at the roadside of a road such as an expressway, and includes the object identification device 10. First, in the present embodiment, an outline of object identification processing performed by the object identification device 10 will be described. In the present embodiment, an object is specifically assumed to be a vehicle on a road.

It is obvious that a vehicle traveling an expressway travels on the expressway. Whether the vehicle travels in a curve is determined by the shape of the expressway. Here, the object identification device 10 of the roadside apparatus 20 installed at the roadside stores information on the shape of the road, that is, map information. By an area indicated by the map information being subdivided into a plurality of regions, the object identification device 10 changes the motion model of a vehicle traveling on a curve for a model in which the vehicle moves on a straight line all the way in each region. Consequently, the object identification device 10 can reduce processing load in the identification of a vehicle or an object, compared to a case where a plurality of motion models including turning is considered.

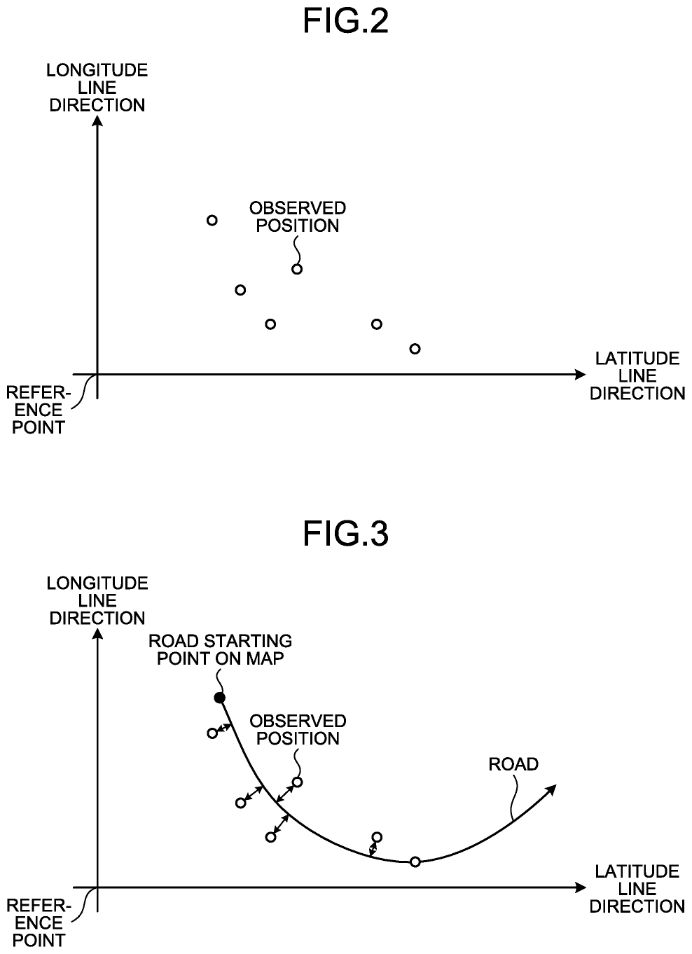

FIG. 2 is a graph illustrating an example in which observed positions of vehicles observed by a device having no map information are plotted in a relative coordinate system parallel to latitude and longitude. Here, as an example, the horizontal axis is the latitude direction, and the vertical axis is the longitude line direction with respect to a certain reference point. In FIG. 2, the positional relationships between the observed positions and the road are unknown. FIG. 3 is a graph illustrating an example in which observed positions of vehicles observed by the object identification device 10 according to the present embodiment are plotted together with an assumed road position. By comparing the observed positions of the vehicles with the road indicated by the map information stored in advance as illustrated in FIG. 3, the object identification device 10 can derive positions in the traveling direction and positions in the transverse direction that is a direction perpendicular to the traveling direction on the vehicles.

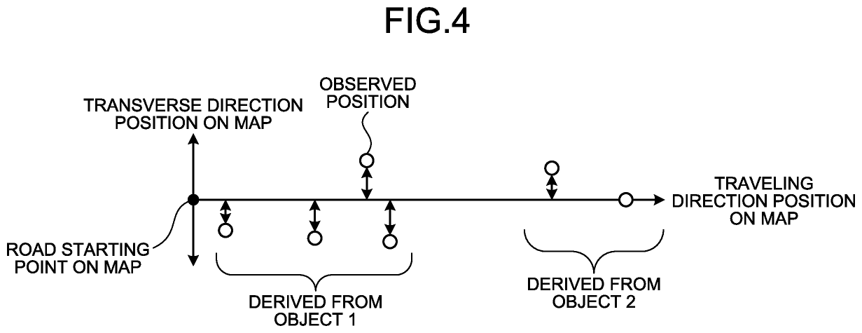

FIG. 4 is a diagram illustrating relative distances of the objects to the road substituted for the observed positions by the object identification device 10 according to the present embodiment. The object identification device 10 substitutes the vehicles traveling on a straight line for the vehicles traveling on the curve as illustrated in FIG. 4, using the map information in which the area is subdivided into the plurality of regions. Thus, the object identification device 10 can easily determine whether two observed positions are derived from the same object or derived from different objects. In FIGS. 3 and 4, a road starting point on the map is information included in the map information. Details of the map information will be described later. In FIG. 4, traveling direction position on the map represents the positions of the vehicles on the road, and transverse direction position on the map represent the positions of the vehicles from the road center in the direction perpendicular to the road, that is, the traveling direction of the vehicles.

The specific configuration and operation of the object identification device 10 will be described. The object identification device 10 includes a sensor installation information storage unit 11, a map information storage unit 12, a common coordinate transformation unit 13, a region determination unit 14, a road reference position conversion unit 15, a position estimation unit 16, a comparison unit, 17, and an identification processing unit 18.

The sensor installation information storage unit 11 stores sensor installation information that is information on the installation positions of the plurality of sensors (not illustrated). Each sensor observes a vehicle at the roadside, and outputs observed position information indicating an observed position that is the position of the vehicle when the sensor has observed the vehicle, to the common coordinate transformation unit 13. It is assumed that there is a plurality of sensors. The sensor installation information is position information in an absolute coordinate system common to the sensors. The sensor installation information may alternatively be position information based on the position of a reference sensor serving as a reference in an absolute coordinate system, and the relative positions of the other sensors to the reference sensor.

The map information storage unit 12 stores map information that is information on the road that vehicles travel. The map information storage unit 12 stores information on the road on the map as a combination of a plurality of straight lines. That is, the map information storage unit 12 stores information on the road, that is, an area managed, as information on a map divided into a plurality of regions according to the curvature of the road. In the divided regions, the road is treated as straight lines. Thus, in the map information, the area indicated by the map information is divided into the plurality of regions, and each divided region is of a size that allows the road to be linearly approximated in the region. The map information stored in the map information storage unit 12 includes division information on the regions, and information such as a passing order of the regions, road starting points in the regions, assumed road directions in the regions, a starting point shared by the entire map, and road starting point distances in the regions.

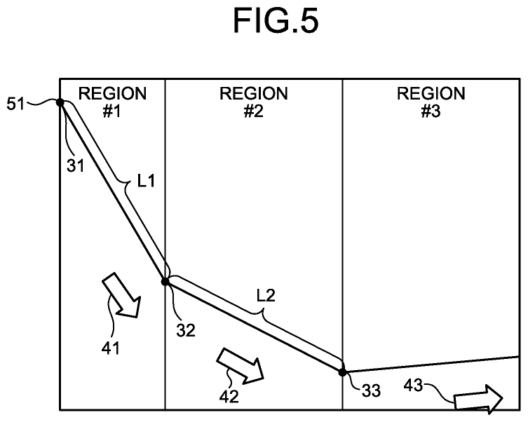

FIG. 5 is a diagram illustrating an example of the contents of the map information stored by the map information storage unit 12 of the object identification device 10 in the present embodiment. The division information on the regions is information indicating the divided state of the area on the map indicated by the map information stored by the map information storage unit 12. The divided state of the area is, for example, the number of divisions of the area on the map indicated by the map information and the shapes of the regions. The example of FIG. 5 shows that the area on the map is divided into three regions #1 to #3, and each region has a rectangular shape. The passing order of the regions indicates the order of the regions through which vehicles pass when traveling in the assumed road directions in the regions. In the example of FIG. 5, identification information such as “#1”, “#2”, and “#3” assigned to the regions corresponds to the passing order of the regions. The road starting point in each region is a reference point of the road in the region, and is information on a starting point at which the road starts in the region. The example of FIG. 5 shows a road starting point 31 in the region #1, a road starting point 32 in the region #2, and a road starting point 33 in the region #3. The assumed road direction in each region is information defining an extended direction of the road in the region. In the following description, the extended direction of the road is simply referred to as the direction of the road. As described above, the road in each region is a straight line. The example of FIG. 5 shows an assumed road direction 41 in the region #1, an assumed road direction 42 in the region #2, and an assumed road direction 43 in the region #3.

A starting point 51 shared by the entire map is the same as the road starting point in the first region, in the example of FIG. 5, the road starting point 31 in the region #1. The starting point 51 shared by the entire map is a reference point of the road indicated by the map information, and is also referred to as a road starting point on the map. The road starting point distance in each region is a distance from the starting point 51 shared by the entire map to the road starting point in the region. As described above, since the road starting point 31 in the region #1 is the same as the starting point 51 shared by the entire map, the road starting point distance in the region #1 is “0”. In the example of FIG. 5, the distance from the starting point 51 shared by the entire map to the road starting point 32 in the region #2 is a road starting point distance L1 in the region #2, and the distance from the starting point 51 shared by the entire map to the road starting point 33 in the region #3 is a road starting point distance (L1+L2) in the region #3. Note that the range of regions of a map indicated by map information only needs to cover a range in which observation of vehicles is required, and may be defined in any form. For example, regions may be specified in rectangular shapes in accordance with a curve, or regions may be divided by circles, trapezoids, or the like. In the example of FIG. 5, it is assumed that vehicles travel in a left-to-right direction. When vehicles travel in a right-to-left direction, the position of the road at the right end in the region #3 may be set as a starting point. When vehicles travel in a right-to-left direction, the position of the road at the left end in the region #1 may be set as a starting point, and the speed of vehicles may be treated as negative.

The description returns to the explanation of FIG. 1. When the observed positions indicated by the observed position information acquired from the plurality of sensors are indicated by the relative positions in the sensors, the common coordinate transformation unit 13 transforms the observed positions into positions in the absolute coordinate system common to the sensors, using the sensor installation information stored in the sensor installation information storage unit 11. For example, when the observed position of a vehicle measured by one of the sensors is in a vector format specified by the direction and distance from the sensor, the common coordinate transformation unit 13 refers to the sensor installation information stored in the sensor installation information storage unit 11, and from the position coordinates of the corresponding sensor, transforms the position in the direction and at the distance represented by the vector into the position of the vehicle represented by an observed position. When the observed position is represented in the common absolute coordinate system shared between the sensors, such as a coordinate system using latitude and longitude, the object identification device 10 can omit the sensor installation information storage unit 11 and the common coordinate transformation unit 13.

The region determination unit 14 acquires the observed position information transformed by the common coordinate transformation unit 13, and determines whether the observed position is in any one of the regions into which the area indicated by the map information is divided. Based on the map information acquired from the map information storage unit 12, the region determination unit 14 determines to which region the observed position belongs, from the division information on the regions included in the map information.

Based on the map information acquired from the map information storage unit 12 and the region determination result of the region determination unit 14, the road reference position conversion unit 15 converts the observed position determined to be in the region of the map information into a traveling direction position of the vehicle indicating a position in a direction parallel to the assumed road direction in the region indicated by the map information, and a transverse direction position of the vehicle indicating a position in a direction perpendicular to the assumed road direction in the region. The road reference position conversion unit 15 also calculates the traveling direction speed of the vehicle at the observed position. The detailed operation of the road reference position conversion unit 15 will be described later.

When the acquisition times of the observed position information acquired from the plurality of sensors vary from observed position information to observed position information, the position estimation unit 16 converts each observed position converted by the road reference position conversion unit 15 into an estimated observed position when the observed position is acquired at a reference time serving as a reference. The detailed operation of the position estimation unit 16 will be described later.

The comparison unit 17 rearranges the observed positions after the position conversion in order of the traveling direction, and compares front and rear observed positions. Specifically, the comparison unit 17 creates pairs of front and rear observed positions in the traveling direction, calculates the difference in the vehicle traveling direction positions, the difference in the vehicle transverse direction positions, and the difference in the vehicle traveling direction speeds between each pair of observed positions, and determines whether the differences are within thresholds specified in the respective items. The comparison unit 17 determines that a pair of observed positions between which the differences are within the thresholds specified in the respective items are derived from the same object, and determines that a pair of observed positions between which at least one of the differences is greater than the threshold are derived from different objects. Note that the comparison unit 17 may calculate the difference in the vehicle traveling direction positions and the difference in the vehicle transverse direction positions between each pair of observed positions, and perform the determination based on whether the differences, here, the two differences are within the thresholds specified in the respective items.

For each pair of observed positions determined to be derived from the same object by the comparison unit 17, the identification processing unit 18 discards the observed position information on one observed position of the two observed positions, or generates observed position information into which the two observed positions are integrated. The identification processing unit 18 outputs an object identification result obtained by repeating the discarding of observed position information or generation of observed position information into which two observed positions are integrated.

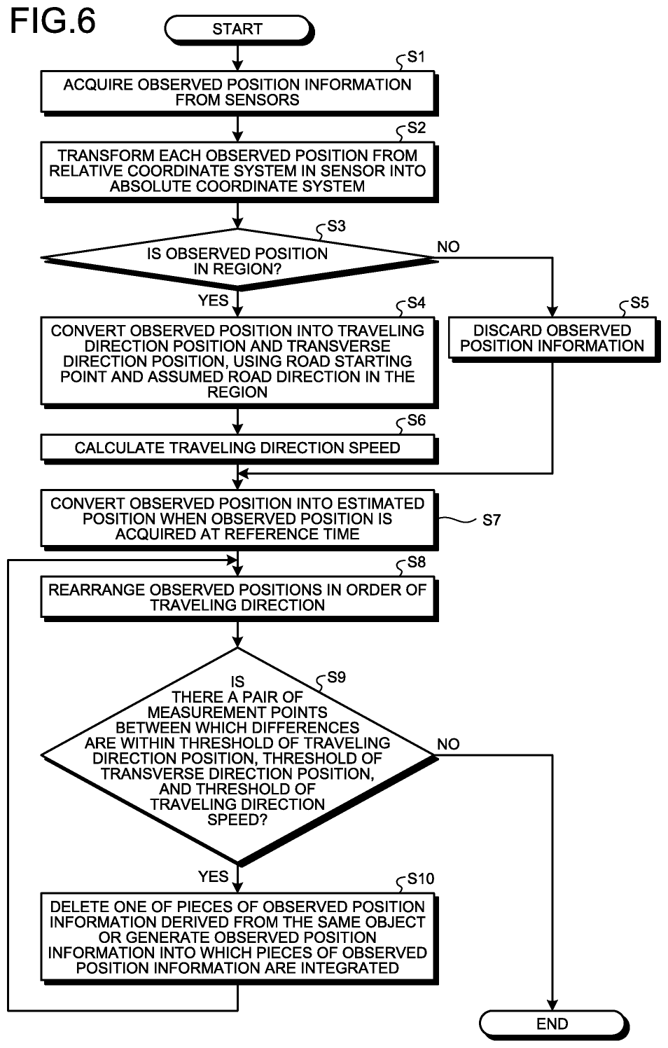

Next, the operation of the object identification device 10 to detect that observed positions indicated by acquired observed position information are derived from the same object, that is, to identify an object will be described. FIG. 6 is a flowchart illustrating the operation of the object identification device 10 according to the present embodiment. First, in the object identification device 10, the common coordinate transformation unit 13 acquires observed position information from the sensors (step S1).

The common coordinate transformation unit 13 transforms each acquired observed position from a relative coordinate system that is relative position information observed by the sensor into an absolute coordinate system common to the sensors such as latitude and longitude or coordinates obtained by transforming latitude and longitude into meters (step S2). When a laser is used as the sensor, for example, the relative position information measured by the sensor may be information such as the distance from the sensor to the observed position and the angle of the observed position as viewed from the sensor. As described above, when the observed positions are described in an absolute coordinate system common between the sensors, instead of relative position information to the sensors, the object identification device 10 can omit the operation in step S2.

The region determination unit 14 acquires the map information from the map information storage unit 12, and determines whether the observed position is in the regions on the map indicated by the map information (step S3). Specifically, the region determination unit 14 determines whether the observed position is included in any one of the regions of the map information illustrated in FIG. 5. When the observed position is in the region indicated by the map information (step S3: Yes), the region determination unit 14 notifies the road reference position conversion unit 15 that the observed position is in the region of the map information. The region determination unit 14 outputs the observed position information to the road reference position conversion unit 15.

The road reference position conversion unit 15 refers to the map information, and converts the observed position into a traveling direction position X and a transverse direction position Y of the vehicle with respect to the road in the map information, using the road starting point and the assumed road direction of the vehicle in the region in which the observed position is included (step S4). The road reference position conversion unit 15 can calculate the traveling direction position X of the vehicle and the transverse direction position Y of the vehicle using the following method, for example. The road reference position conversion unit 15, however, may use any calculation method by which the traveling direction position X of the vehicle and the transverse direction position Y of the vehicle can be calculated.

It is considered that the assumed road direction of the vehicle is parallel to the traveling direction of the vehicle, and the assumed road direction of the vehicle is perpendicular to the transverse direction of the vehicle. Thus, letting β be the angle of the assumed road direction relative to a specified direction on the map, a traveling direction road vector D(bold)ₕₒᵣ is defined as in formula (1), and a transverse direction road vector D(bold)ᵥₑᵣ is defined as in formula (2).

D(bold)ₕₒᵣ=(cosβ, sinβ) (1)

D(bold)ᵥₑᵣ=(cos(β−π/2), sin(β−π/2)) (2)

Let a certain point in the map be origin point (0, 0) of the map, and observed coordinates of the vehicle, that is, the observed position be S(bold)=(a, b). Letting the coordinates of the road starting point in the region be P(bold)_{road}=(X_{road}, Y_{road}), the road reference position conversion unit 15 can calculate a traveling direction position Xₐᵣₑₐ in the region by formula (3), and calculate a transverse direction position Yₐᵣₑₐ in the region by formula (4).

Xₐᵣₑₐ=D(bold)ₕₒᵣ·(S(bold)−P(bold)_{road}) (3)

Yₐᵣₑₐ=D(bold)ᵥₑᵣ·(S(bold)−P(bold)_{road}) (4)

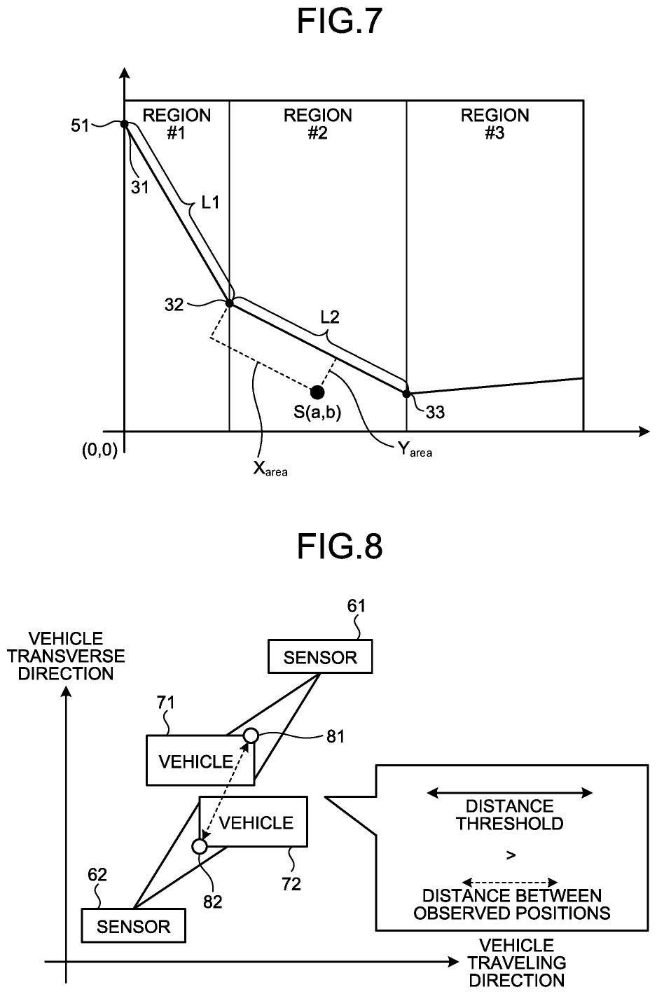

Of them, the traveling direction position Xₐᵣₑₐ in the region represents the distance from the road starting point coordinates in the region. However, in practice, it is necessary to calculate the traveling direction distance from the starting point 51 shared by the entire map. Thus, the distance from the starting point 51 shared by the entire map to the starting point in the region including the observed position is added. FIG. 7 is a diagram illustrating an example of processing in the object identification device 10 according to the present embodiment to convert the observed position information into the traveling direction position in the region and the transverse direction position in the region. For example, in FIG. 7, when an observed position S is in the region #2, a value obtained by adding the distance from the starting point 51 shared by the entire map to the road starting point 32 in the region #2, that is, the road starting point distance L1 in the region #2 to the traveling direction position Xₐᵣₑₐ in the region is the traveling direction position X of the vehicle. When the observed position S is in the region #1, the starting point 51 shared by the entire map coincides with the road starting point 31 in the region #1, and thus the traveling direction position Xₐᵣₑₐ in the region is the traveling direction position X of the vehicle. When the observed position S is in the region #3, a value obtained by adding the distance from the starting point 51 shared by the entire map to the road starting point 33 in the region #3, that is, the road starting point distance (L1+L2) in the region #3 to the traveling direction position Xₐᵣₑₐ in the region is the traveling direction position X of the vehicle. On the other hand, the transverse direction position Yₐᵣₑₐ in the region coincides with a desired transverse direction position Y of the vehicle.

Thus, the road reference position conversion unit 15 can calculate the traveling direction position X of the vehicle and the transverse direction position Y of the vehicle, using the map information. The road reference position conversion unit 15 calculates a traveling direction speed indicating the speed of the vehicle in the traveling direction (step S6). Specifically, when the sensor is a radar, for example, the road reference position conversion unit 15 can calculate a traveling direction speed V_{X} from a Doppler velocity V_{get} projected in an observed direction, using the angle γ between the assumed road direction of the vehicle and the measurement direction of the sensor, as in formula (5).

V_{X}=V_{get}/cosγ (5)

When the observed position is not in any region indicated by the map information (step S3: No), the region determination unit 14 discards the observed position information (step S5).

Here, it is expected that the sensors connected to the object identification device 10 have different measurement cycles. In this case, in the object identification device 10, pieces of observed position information observed by the sensors are collected at different times. In the object identification device 10, it is important to compare past data and current data even if they are pieces of observed position information from the same sensor, to determine how the same vehicle has traveled. However, the pieces of observed position information acquired at different times cannot be simply compared because the vehicle has traveled. The position estimation unit 16 converts the observed positions acquired at different times into estimated observed positions when the observed positions are acquired at a reference time serving as a base time (step S7).

Here, let the reference time be T_{ref}, and the acquisition time of observed position information be T_{get}. The traveling direction of the vehicle can be regarded as a straight line relative to the assumed road direction in the region included in the map information stored in the map information storage unit 12 of the object identification device 10. When a dynamic map with a fast update cycle, for example, an update cycle of 100 ms or less is utilized, the time difference between the reference time T_{ref} and the observed position acquisition time T_{get} is short, and the vehicle can be considered to be moving at a constant speed. That is, the position estimation unit 16 can calculate an estimated traveling direction position Xₑₛₜ of the vehicle, an estimated transverse direction position Yₑₛₜ of the vehicle, and an estimated traveling direction speed Vₑₛₜ of the vehicle at the reference time T_{ref}, using the traveling direction position X, the transverse direction position Y of the vehicle, and the traveling direction speed V_{X} of the vehicle at the acquisition time T_{get}, assuming that the vehicle observed at the acquisition time T_{get} of the observed position information has made a uniform linear motion. Specifically, the position estimation unit 16 can easily calculate the estimated traveling direction position Xₑₛₜ, the estimated transverse direction position Yₑₛₜ, and the estimated traveling direction speed Vₑₛₜ at the reference time T_{ref} by the following formulas (6) to (8).

Xₑₛₜ=X+V_{X}×(T_{ref}−T_{get}) (6)

Yₑₛₜ=X (7)

Vₑₛₜ=V (8)

Thus, the position estimation unit 16 can treat the pieces of data of observed position information at the different acquisition times T_{get} as those acquired at the same reference time T_{ref}. By representing the vehicle in the traveling direction and the transverse direction, using the map information, the position estimation unit 16 can perform estimation processing, assuming that the vehicle has made a uniform linear motion regardless of whether the road is a straight line or a curve. The reference time T_{ref} may be the next transmission time of the dynamic map, or the previous transmission time of the dynamic map or the like may be used. When the measurement cycles of the sensors are the same and synchronized, the object identification device 10 can omit the operation in step S6. Even if acquisition times are strictly different, the position estimation unit 16 may regard acquisition times in a specified period as the same. The specified period is, for example, the time required to travel a distance less than the length of one vehicle, in consideration of the speed of the vehicle.

Next, the comparison unit 17 rearranges the observed positions that can be considered to be simultaneously acquired by the processing of the position estimation unit 16, in order of the vehicle traveling direction (step S8). On the observed positions rearranged in order of the vehicle traveling direction, the comparison unit 17 creates pairs of front and rear observed positions in the order, and calculates the difference in the vehicle traveling direction positions, the difference in the vehicle transverse direction positions, and the difference in the vehicle traveling direction speeds, between each pair of observed positions. The comparison unit 17 determines whether there is a pair of observed positions between which the differences are within the thresholds specified in the respective items, specifically, the threshold of the vehicle traveling direction position, the threshold of the vehicle transverse direction position, and the threshold of the vehicle traveling direction speed (step S9). The threshold of the vehicle traveling direction position is set, for example, within 18 m based on the vehicle length. The threshold of the vehicle transverse direction is set, for example, to the vehicle width or the road width, specifically, to 3.5 m or so for an expressway. The threshold of the vehicle traveling direction speed is set, for example, within ±α km/h.

When the differences are within the threshold of the vehicle traveling direction position, the threshold of the vehicle transverse direction position, and the threshold of the vehicle traveling direction speed (step S9: Yes), the comparison unit 17 determines that the pair of observed positions between which the differences are within the thresholds specified in the respective items are derived from the same object. The comparison unit 17 notifies the identification processing unit 18 of the determination result. For the pair of observed positions determined to be derived from the same object, the identification processing unit 18 deletes the observed position information on one observed position of the two observed positions, or generates observed position information into which the two observed positions are integrated (step S10). The object identification device 10 repeatedly executes the processing until there is no pair of observed positions between which the differences are within the thresholds in step S9. When there is no pair of observed positions between which the differences are within the thresholds, that is, No in step S9, the processing is ended.

The effects obtained by the object identification device 10 performing the above processing will be specifically described.

(1) Comparison with a case where no map information is stored

Compared with the case where no map information is stored, the object identification device 10 can determine whether observed positions are derived from the same object by providing different thresholds for the vehicle traveling direction position and the vehicle transverse direction position. Specifically, the object identification device 10 can compare vehicle positions using two types of thresholds, the threshold of the vehicle traveling direction position and the threshold of the vehicle transverse direction position. On the other hand, a device not storing map information performs determination of whether observed positions are derived from the same object by comparing vehicle positions based on a relative distance between two points of the observed positions, that is, using only one type of distance threshold. Thus, there is a possibility that a vehicle in the next lane may be regarded as the same object. This is because the distance between vehicles in the transverse direction is short while the vehicle body is long in the traveling direction. For example, the road width may be 3.5 m or less while a large car is 10 m long. FIG. 8 is a diagram illustrating an example in which the device not storing map information erroneously determines that two observed positions are derived from the same object. FIG. 8 illustrates the positional relationship between an observed position 81 when a sensor 61 observes a vehicle 71 and an observed position 82 when a sensor 62 observes a vehicle 72. Thus, when the distance between the observed positions 81 and 82 is equal to or less than one type of distance threshold, the device not storing map information erroneously determines that the observed positions 81 and 82 are observed positions derived from the same object. By contrast, the object identification device 10 can avoid such erroneous determination by reducing the threshold of the vehicle transverse direction position compared to the threshold of the vehicle traveling direction position. Further, by storing the map information, the object identification device 10 can perform processing on the assumption that a vehicle is in uniform linear motion in each region.

(2) Comparison with a case where the map information is stored as a function of the road

The object identification device 10 may store the map information in the form of expressing the shape of the road by a function. However, it is difficult to express the shape of the road in the form of a general function because the shape of the road is generated from a complex combination of a straight line, an arc, a clothoid curve, a parabola, etc., and the actual road includes production errors. When an arbitrary nth-order polynomial is modeled from actual measured values of the map, overfitting may occur depending on a polynomial interpolation method, and a road with a shape completely different from the original shape of the road may be modeled. For a road expressed in the form of a function, it is necessary to perform calculation for determining a perpendicular between the observed position and the function to determine the transverse direction position, integration of the function for determining the traveling direction position, calculation of a tangential direction for calculating the traveling direction of the observed position, etc. Depending on the form of the function of the road, the calculation may become complicated, that is, processing load may be increased. By contrast, as described above, the object identification device 10 can reduce processing load by using the map information in which the road is divided into the regions that allow linear approximation.

(3) Comparison with a case where the map information is stored as a function of the road, and only an assumed road direction is acquired

After road information is stored in the form of a function, it is possible, from the function, to acquire only information on an assumed road direction based on a derivative value of the function, and calculate the difference in traveling direction positions and the difference in transverse direction positions between observed positions, individually, using the assumed road direction as the traveling direction. However, the difference in the traveling direction positions and the difference in the transverse direction positions must be determined based on position information on objects from a unified standard of the map. In this case, calculation using all combinations of observed positions is required. Thus, for m observed positions, calculation of the differences between the observed positions requires ₘC₂ operations. By contrast, the object identification device 10 storing the map information calculates the difference in the traveling direction positions between front and rear observed positions, and thus for m observed positions, performs m−1 operations to calculate the differences between the positions necessary for the identification of an object, and can reduce processing load.

Next, the hardware configuration of the object identification device 10 will be described. In the object identification device 10, the sensor installation information storage unit 11 and the map information storage unit 12 are memory. The common coordinate transformation unit 13, the region determination unit 14, the road reference position conversion unit 15, the position estimation unit 16, the comparison unit 17, and the identification processing unit 18 are implemented by a processing circuit. That is, the object identification device 10 includes a processing circuit for determining whether observed positions are derived from the same object. The processing circuit may be a processor for executing programs stored in memory and the memory, or may be dedicated hardware.

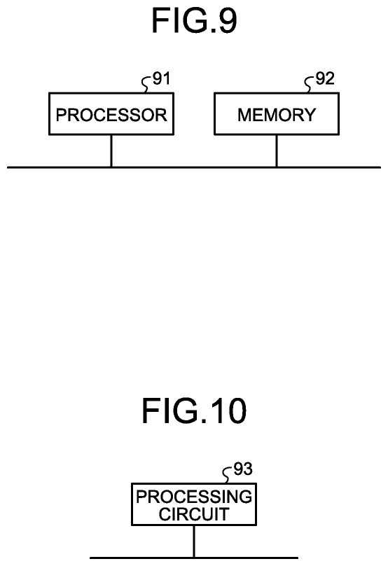

FIG. 9 is a diagram illustrating an example of a case where the processing circuit of the object identification device 10 according to the present embodiment is formed of a processor and memory. When the processing circuit is formed of a processor 91 and memory 92, the functions of the processing circuit of the object identification device 10 are implemented by software, firmware, or a combination of software and firmware. Software or firmware is described as programs and stored in the memory 92. In the processing circuit, the processor 91 reads and executes the programs stored in the memory 92, thereby implementing the functions. That is, in the object identification device 10, the processing circuit includes the memory 92 for storing programs that result in the execution of the determination of whether observed positions are derived from the same object. These programs can be said to cause a computer to perform the procedure and method in the object identification device 10. The memory of the sensor installation information storage unit 11 and the map information storage unit 12 may be the same as the memory 92.

Here, the processor 91 may be a Central Processing Unit (CPU), a processing unit, an arithmetic unit, a microprocessor, a microcomputer, a Digital Signal Processor (DSP), or the like. The memory 92 corresponds, for example, to nonvolatile or volatile semiconductor memory such as Random Access Memory (RAM), Read Only Memory (ROM), a flash memory, an Erasable Programmable ROM (EPROM), or an Electrically EPROM (EEPROM) (registered trademark), or a magnetic disk, a flexible disk, an optical disk, a compact disk, a mini disk, a Digital Versatile Disc (DVD), or the like.

FIG. 10 is a diagram illustrating an example of a case where the procedure circuit of the object identification device 10 according to the present embodiment is formed of dedicated hardware. When the processing circuit is formed of dedicated hardware, a processing circuit 93 illustrated in FIG. 10 corresponds, for example, to a single circuit, a combined circuit, a programmed processor, a parallel-programmed processor, an Application Specific Integrated Circuit (ASIC), a Field Programmable Gate Array (FPGA), or a combination of them. The functions of the object identification device 10 may be implemented by the processing circuit 93 on an individual function basis, or the functions may be collectively implemented by the processing circuit 93.

Note that the functions of the object identification device 10 may be implemented partly by dedicated hardware and partly by software or firmware. Thus, the processing circuit can implement the above-described functions by dedicated hardware, software, firmware, or a combination of them.

As described above, according to the present embodiment, the object identification device 10 stores map information, and an area indicated by the map information is subdivided into a plurality of regions, whereby a motion model of a vehicle traveling on a curve is substituted by a model in which the vehicle moves on a straight line all the way in each region. Consequently, the object identification device 10 can reduce processing load when identifying an object, that is, a vehicle.

The configuration described in the above embodiment illustrates an example of the subject matter of the present invention, and can be combined with another known art, and can be partly omitted or changed without departing from the scope of the present invention.

### REFERENCE SIGNS LIST

10 object identification device; 11 sensor installation information storage unit; 12 map information storage unit; 13 common coordinate transformation unit; 14 region determination unit; 15 road reference position conversion unit; 16 position estimation unit; 17 comparison unit; 18 identification processing unit; 20 roadside apparatus.

1. An object identification device comprising:
a map information storage circuit to store map information indicating information on a road;
a region determination circuit to acquire observed position information indicating observed positions at which an object is observed from a plurality of sensors, and determine whether each observed position is in any one of regions into which an area indicated by the map information is divided;
a road reference position conversion circuit to convert each observed position determined to be in the region of the map information, into a traveling direction position indicating a position in a direction parallel to an assumed road direction in the region indicated by the map information, and a transverse direction position indicating a position in a direction perpendicular to the assumed road direction in the region, using the map information; and
a comparison circuit to rearrange the observed positions in order of the traveling direction, create pairs of front and rear observed positions in the traveling direction, calculate a difference in the traveling direction positions and a difference in the transverse direction positions between each pair of observed positions, and determine that a pair of observed positions between which the differences are within thresholds specified in respective items are derived from the same object, and determine that a pair of observed positions between which at least one of the differences is greater than the threshold are derived from different objects.

2. The object identification device according to claim 1, wherein
the road reference position conversion circuit further calculates a traveling direction speed indicating a speed of the object in the traveling direction at each observed position determined to be in the region of the map information, and
the comparison circuit further calculates a difference in the traveling direction speeds between each pair of observed positions, and determines that a pair of observed positions between which the differences are within thresholds specified in respective items are derived from the same object, and determines that a pair of observed positions between which at least one of the differences is greater than the threshold are derived from different objects.

3. The object identification device according to claim 1, wherein
in the map information, the area indicated by the map information is divided into a plurality of regions, and each divided region is of a size that allows the road to be linearly approximated in the region.

4. The object identification device according to claim 3, wherein
the map information includes a starting point shared by an entire map that is a reference point of the road indicated by the map information, a road starting point in each region that is a reference point of the road in the region, division information on the regions indicating a divided state of the area on the map indicated by the map information, an assumed road direction in each region defining a direction of the road in the region, a passing order of the regions indicating an order of the regions through which the object passes when traveling in the assumed road directions in the regions, and information on a road starting point distance in each region indicating a distance from the starting point shared by the entire map to the road starting point in the region.

5. The object identification device according to claim 1, further comprising:
an identification processing circuit to delete, on the pair of observed positions determined to be derived from the same object by the comparison circuit, the observed position information on one observed position of the two observed positions, or generate observed position information into which the two observed positions are integrated.

6. The object identification device according to claim 1, further comprising:
a sensor installation information storage circuit to store sensor installation information that is information on installation positions of the plurality of sensors; and
a common coordinate transformation circuit to transform the observed positions indicated by the observed position information acquired from the plurality of sensors into positions of absolute coordinates common to the sensors, using the sensor installation information, when the observed positions are indicated by relative positions in the sensors.

7. The object identification device according to claim 1, further comprising:
a position estimation circuit to convert each observed position converted by the road reference position conversion circuit into an estimated observed position when the observed position is acquired at a reference time serving as a reference, when acquisition times of the observed position information acquired from the plurality of sensors vary from observed position information to observed position information.

8. A roadside apparatus comprising the object identification device according to claim 1.

9. An object identification method comprising:
by a region determination circuit, acquiring observed position information indicating observed positions at which an object is observed from a plurality of sensors, and determining whether each observed position is in any one of regions into which an area indicated by map information that is information on a road is divided;
by a road reference position conversion circuit, converting each observed position determined to be in the region of the map information, into a traveling direction position indicating a position in a direction parallel to an assumed road direction in the region indicated by the map information, and a transverse direction position indicating a position in a direction perpendicular to the assumed road direction in the region, using the map information; and
by a comparison circuit, rearranging the observed positions after the position conversion in order of the traveling direction, creating pairs of front and rear observed positions in the traveling direction, calculating a difference in the traveling direction positions and a difference in the transverse direction positions between each pair of observed positions, and determining that a pair of observed positions between which the differences are within thresholds specified in respective items are derived from the same object, and determining that a pair of observed positions between which at least one of the differences is greater than the threshold are derived from different objects.
